(19) United States
(12) Patent Application Publication
(10) Pub. No.: US 2021/0354089 A1
(43) Pub. Date: Nov. 18, 2021

(54) PREPARATION METHOD OF HIGH-PERFORMANCE MABR HOLLOW FIBER COMPOSITE MEMBRANE

(71) Applicant: Zhejiang Changxing Creflux Membrane Technology Co., Ltd., Huzhou (CN)

(72) Inventors: Hao Wu, Huzhou (CN); Hongmei Shen, Huzhou (CN); Fu Huang, Huzhou (CN); Zhipeng Xu, Huzhou (CN); Shantian Xu, Huzhou (CN); Limin Cao, Huzhou (CN); Jinfeng Bao, Huzhou (CN)

(73) Assignee: Zhejiang Changxing Creflux Membrane Technology Co., Ltd., Huzhou (CN)

(21) Appl. No.: 16/948,768

(22) Filed: Sep. 30, 2020

Related U.S. Application Data
(63) Continuation of application No. PCT/CN2020/117466, filed on Sep. 24, 2020.

(30) Foreign Application Priority Data
May 18, 2020 (CN) 202010419995.0

(51) Int. Cl. B01D 67/00; B01D 69/12; B01D 69/10; B01D 69/02; B01D 71/26; B01D 71/34; B01D 71/36; B01D 69/08; C02F 3/12

(52) U.S. Cl. CPC B01D 67/0088; B01D 69/12; B01D 69/105; B01D 69/02; B01D 71/26; B01D 2325/10; B01D 71/36; B01D 69/08; C02F 3/1268; B01D 2325/38; B01D 71/34

(57) ABSTRACT

The invention relates to the technical field of membrane separation, in particular to and discloses a preparation method of a high-performance MABR hollow fiber composite membrane, which comprises the following steps: 1) pretreating a supporting membrane, which includes: soaking the supporting membrane in ethanol, then soaking the supporting membrane in pure water, and then removing residual water; 2) preparing a coating solution, which includes: mixing raw silicone rubber and a reinforcing material with a continuous stirring, adding a crosslinking agent and a catalyst and stirring well, adding a solvent to dilute to a required concentration, and perform a vacuum defoaming; 3) coating the pretreated supporting membrane, which includes: coating and pulling; and 4) performing a curing, which includes: placing the membrane in an oven for curing. With the preparation method of the high-performance MABR hollow fiber composite membrane according to this invention, the prepared composite membrane has a higher oxygen permeability and a higher bubble point pressure of the dry membrane, which facilitates the transmission of oxygen across the membrane and enables the composite membrane to bear a higher aeration pressure during its operation, and ensures the operation efficiency of the MABR system, with advantages of a simple and feasible process, a suitability for the microporous support membrane of various materials and a good modification effect.

### CLAIM OF PRIORITY

This application is a continuation application of International Application No. PCT/CN2020/117466, filed 24 Sep. 2020, which claims the benefit of priority to Chinese Application No. 202010419995.0, filed 18 May 2020, the benefit of priority of each of which is claimed herein, and which applications are hereby incorporated herein by reference in their entirety.

### TECHNICAL FIELD

The invention relates to a technical field of membrane separation, in particular to a preparation method of a high-performance MABR hollow fiber composite membrane.

### BACKGROUND ART

Membrane Aeration Biofilm Reactor (MABR) is a new technology for wastewater treatment and a new form of a membrane bioreactor. MABR is based on a breathable membrane, through which a gaseous substrate is supplied to a biofilm formed outside the membrane. Microbe in MABR biofilm has a unique colony structure due to oxygen and pollutants enter the biofilm from its both sides, and different layered microbes have different pollutant treating capabilities. Main advantages of MABR include a high gas utilization efficiency, a low energy consumption and a small reactor footprint. MABR has great technical advantages and a wide application prospect in enhancing degradation of organic wastewater.

As a wastewater treatment technology with a lower energy consumption and higher efficiency, MABR has attracted more and more attention. MABR has been widely used in many fields such as river regulation, medical wastewater treatment and municipal wastewater treatment.

In MABR technology, a high-performance MABR membrane is a basis of the whole process, and a selecting of a suitable membrane material is a key factor to improve operation efficiency of MABR. According to different membrane structures, the MABR membrane can be in three types: a hydrophobic microporous membrane, such as a polypropylene (PP) membrane and a polytetrafluoroethylene (PTFE) membrane; a non-porous dense membrane, such as a PP membrane, a silicone rubber (Polydimethylsiloxane, PDMS) membrane and a poly(4-methyl-1-pentene) membrane; and a composite membrane, namely a composite membrane with a dense layer and a microporous support layer.

A hydrophobic microporous membrane has a poor selectivity for oxygen and a low bubble point pressure, and microporous membrane is easily blocked by microbe during a long-term operation, which leads to a decreased operation efficiency. Although the dense membrane has a higher bubble point pressure, a larger gas transmission resistance due to its dense structure. The composite membrane is made by coating a thin layer (several microns) of a breathable material (such as silicone rubber, polyaniline and the like) on a surface of the hydrophobic microporous membrane, which is actually an ultra-thin dense membrane with the hydrophobic microporous membrane being its support, in which this surface coating not only improves a disadvantage of the low bubble point pressure of the hydrophobic microporous membrane, but also retains its advantages of a low gas transmission resistance and a large flux. Therefore, there is an urgent need to manufacture the composite membrane with a large oxygen flux and a dense membrane strength.

### SUMMARY

In view of problems existing in the prior art, the invention provides a preparation method of a high-performance MABR hollow fiber composite membrane.

In order to achieve the purpose of the invention, the invention adopts the following technical scheme:

a preparation method of a high-performance MABR hollow fiber composite membrane includes the following steps:

1) pretreating a supporting membrane, which includes: soaking the supporting membrane in ethanol for 3-5 minutes, soaking the supporting membrane in pure water for 2-5 times each for 5-10 minutes, and then removing residual water on a surface of the supporting membrane with compressed air. The pretreating of the supporting membrane can effectively prevent an infiltration of a subsequent coating solution, and a thinner dense layer of silicone rubber can be obtained, which will undoubtedly be beneficial for a transmission of oxygen across the membrane;

2) preparing a coating solution, which includes: mixing raw silicone rubber and a reinforcing material with a continuous stirring for 30-90 minutes, then adding a crosslinking agent and catalyst and stirring well for 30-60 minutes, and finally adding a diluting solvent to dilute to a required concentration so as to obtain the coating solution after a vacuum defoaming, and the raw silicone rubber, the reinforcing material, the crosslinking agent and catalyst are added in a certain proportion; the reinforced material added in silicone rubber can significantly improve strength of the dense layer of silicone rubber, and a higher strength of the dense layer means that the composite membrane can withstand a higher aeration pressure during an operation, which will facilitate to ensure an operation efficiency of a MABR system;

3) coating the pretreated supporting membrane, which includes: placing the pretreated supporting membrane in step 1) into the coating solution prepared in step 2) for 30-90 seconds, and then pulling the supporting membrane out of the coating solution at a constant speed by a vertical pulling machine. A process of preparing the hollow fiber composite membrane by soaking and pulling method is more favorable for an industrialized continuous process;

4) performing a curing, which includes: placing the resulting membrane obtained in step 3) in an oven at 50-120° C. for curing, and obtaining the hollow fiber composite membrane after a complete curing.

Preferably, the method further comprises a step 5) of repeating the step 3) and the step 4) at least once. With repeated coatings and curings, composite membranes with a higher bubble point pressure of the dry membrane and a more silicone rubber loading can be produced.

Preferably, the supporting membrane described in step 1) is a hydrophobic microporous membrane, a membrane material thereof can be polypropylene (PP), polyethylene (PE), polyvinylidene fluoride (PVDF) or polytetrafluoroethylene (PTFE), the microporous membrane has an inner diameter of 300-720 μm, a wall thickness of 80-200 μm, and a membrane surface aperture of 0.1˜0.8 μm.

Preferably, the raw silicone rubber in step 2) is vinyl silicone oil, the crosslinking agent is low molecular vinyl silicone oil and/or hydrosilicone oil, and the catalyst is Karstedt's catalyst.

Preferably, the reinforcing material in step 2) is one or more of white carbon black, celite and nano calcium carbonate.

Preferably, the diluting solvent in step 2) is one or more of n-hexane, n-heptane, cyclohexane and petroleum ether.

Preferably, when the raw silicone rubber in step 2) is in 1 part by weight, the reinforcing material is 0.05-0.5 part by weight, the crosslinking agent is 0.05-0.2 part by weight, and the catalyst is 0.01-0.1 part by weight, and the dilution solvent is added until a weight percentage of the raw silicone rubber in the whole solution is 10-40 wt %.

With the preparation method of the high-performance MABR hollow fiber composite membrane according to this invention, the prepared composite membrane combined with the microporous structure and the dense layer has a higher oxygen permeability and a higher bubble point pressure of the dry membrane, which facilitates the transmission of oxygen across the membrane, enables the composite membrane to bear a higher aeration pressure during its operation, facilitates to ensure the operation efficiency of the MABR system, and has a good application prospect in the MABR field, with advantages of a simple and feasible process, a suitability for the microporous support membrane of various materials and a good modification effect.

### BRIEF DESCRIPTION OF DRAWINGS

FIG. 1 is an SEM image of a surface of a PE supporting membrane in Example 1.

FIG. 2 is an SEM image of a surface of a PDMS/PE-1 composite membrane prepared by the preparation method of high-performance MABR hollow fiber composite membrane described in Example 1.

FIG. 3 is an SEM image of a surface of PP supporting membrane in Example 2.

FIG. 4 is an SEM image of a surface of a PDMS/PP composite membrane prepared by the preparation method of high-performance MABR hollow fiber composite membrane described in Example 2.

FIG. 5 is an SEM image of a surface of PVDF supporting membrane in Example 3.

FIG. 6 is an SEM image of a surface of a PDMS/PVDF composite membrane prepared by the preparation method of high-performance MABR hollow fiber composite membrane described in Example 3.

### DETAILED DESCRIPTION OF PREFERRED EMBODIMENTS

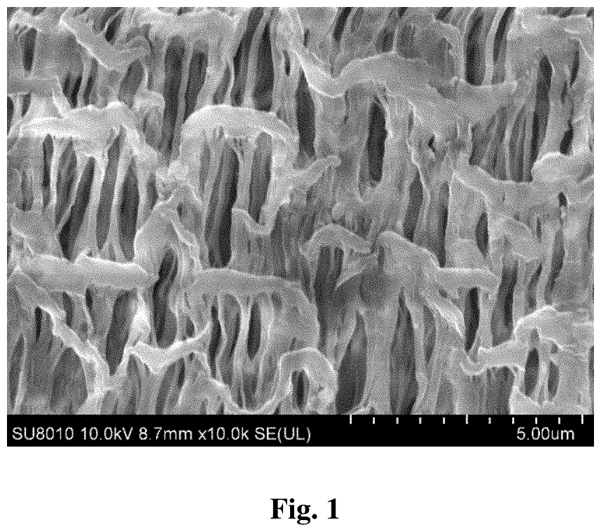

The present invention will be further explained with reference to FIGS. 1-6 and specific embodiments.

### EXAMPLE 1

A preparation method of a high-performance MABR hollow fiber composite membrane includes the following steps:

1) pretreating a supporting membrane, the supporting membrane is a hydrophobic microporous membrane, and a membrane material thereof is polyethylene (PE), the PE supporting membrane has an inner diameter of 300 μm, a wall thickness of 80 μm, and a membrane surface aperture of 0.3 μm.

The supporting membrane is soaked in ethanol for 5 minutes, then is soaked within pure water for 2 times each for 10 minutes, and then residual water on a surface of the PE supporting membrane are removed with compressed air.

2) preparing a coating solution, in which: vinyl silicone oil is used as raw silicone rubber, white carbon black is used as a reinforcing material, hydrosilicone oil is used as a crosslinking agent, Karstedt's catalyst is used as a catalyst, and n-hexane is used as a diluting solvent; and 1 part of vinyl silicone oil and 0.05 part of white carbon black are mixed and stirred for 60 minutes, then 0.1 part of hydrosilicone oil and 0.01 part of Karstedt's catalyst are added and stirred well for 30 minutes, and then a proper amount of n-hexane is added to make a weight percentage of the raw silicone rubber in the whole solution to be 10 wt %, and finally the Polydimethylsiloxane (PDMS) coating solution is prepared after a vacuum defoaming;

3) coating the pretreated supporting membrane, which includes: placing the pretreated PE supporting membrane in step 1) into the coating solution prepared in step 2) for 30s seconds, and then pulling the supporting membrane out of the coating solution at a constant speed by a vertical pulling machine;

4) performing a curing, which includes: placing the resulting membrane obtained in step 3) in an oven at 100° C. for curing until a complete curing is obtained;

5): repeating step 3) and step 4) twice to prepare a PDMS/PE-1 hollow fiber composite membrane after a complete curing.

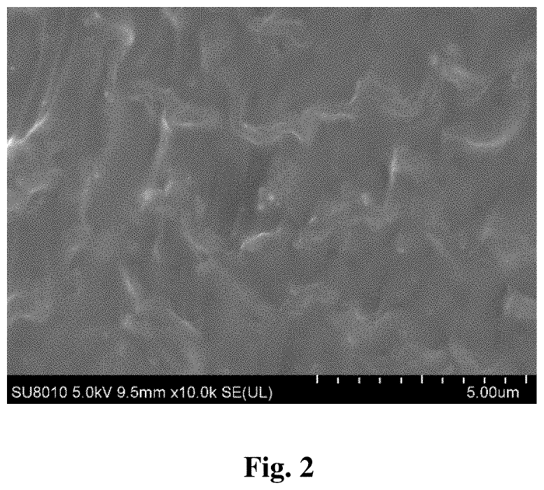

A SEM image of a surface of the PE supporting membrane and a SEM image of a surface of the prepared PDMS/PE-1 hollow fiber composite membrane is shown in FIGS. 1 and 2. It can be clearly seen that the unmodified PE membrane has an obvious microscale pore structure on its membrane surface, and as mentioned above, micropores in the microporous membrane are prone to blockage in practical use, which leads to a decrease of a mass transfer efficiency of the membrane. However, the PDMS/PE-1 composite membrane prepared by PDMS modification has a completely compact surface, which indicates that a continuous and compact PDMS layer has been successfully compounded on the surface of microporous PE supporting membrane.

Ten prepared composite membranes were packed in a PU hose with polyurethane glue, were subjected to a cut end after the glue was completely cured, and were tested for the oxygen permeability and the bubble point pressure of the dry membrane, with air as a gas source and the aeration pressure of 0.01 MPa during the test. The results are shown in Table 1.

TABLE 1

| | | Bubble Point |
|---|---|---|
| | Oxygen Permeability | Pressure of Dry |
| Name | (g O₂/m² day) | Membrane (MPa) |
| PE | — | 0.0015 |
| PDMS/PE-1 | 19.79 | 0.1 |

It can be seen from Table 1 that the bubble point pressure of the microporous PE supporting membrane is low due to its microporous structure, which means that a higher aeration pressure cannot be used in the microporous PE membrane during MABR operations, and this will undoubtedly limit an aeration efficiency. However, the bubble point pressure of the PDMS/PE-1 composite membrane prepared by modification is significantly increased, and at the same time, the composite membrane also has an extremely high oxygen permeability.

### EXAMPLE 2

A preparation method of a high-performance MABR hollow fiber composite membrane includes the following steps:

1) pretreating a supporting membrane, the supporting membrane is a hydrophobic microporous membrane, and a membrane material thereof is polypropylene (PP), the PE supporting membrane has an inner diameter of 400 μm, a wall thickness of 100 μm, and a membrane surface aperture of 0.3 μm.

The supporting membrane is soaked in ethanol for 4 minutes, then is soaked within pure water for 5 times each for 10 minutes, and then residual water on the surface of the PP supporting membrane are removed with compressed air.

2) preparing a coating solution, in which: vinyl silicone oil is used as the raw silicone rubber, nano calcium carbonate is used as the reinforcing material, hydrosilicone oil is used as the crosslinking agent, Karstedt's catalyst is used as the catalyst, and n-hexane is used as the diluting solvent; and 1 part of vinyl silicone oil and 0.05 part of nano calcium carbonate are mixed and stirred for 50 minutes, then 0.1 part of hydrosilicone oil and 0.01 part of Karstedt's catalyst are added and stirred well for 50 minutes, and then a proper amount of n-hexane and n-heptane is added to make a weight percentage of the raw silicone rubber in the whole solution to be 30 wt %, and finally the Poly(dimethylsiloxane) (PDMS) coating solution is prepared after the vacuum defoaming;

3) coating the pretreated supporting membrane, which includes: placing the pretreated PP supporting membrane in step 1) into the coating solution prepared in step 2) for 60 seconds, and then pulling the supporting membrane out of the coating solution at a constant speed by the vertical pulling machine;

4) performing a curing, which includes: placing the resulting membrane obtained in step 3) in an oven at 60° C. for curing until a complete curing is obtained, and obtaining the prepared PDMS/PP hollow fiber composite membrane after a complete curing.

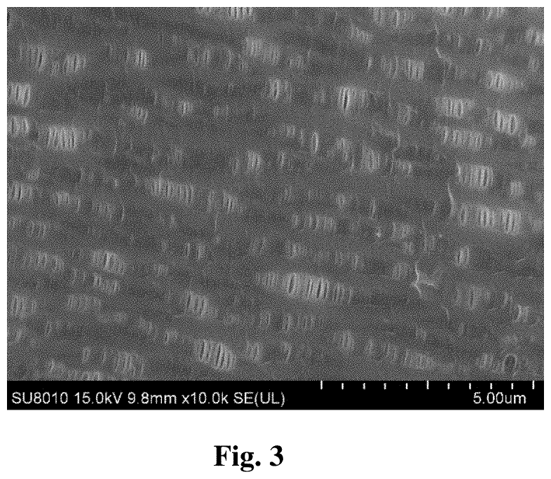

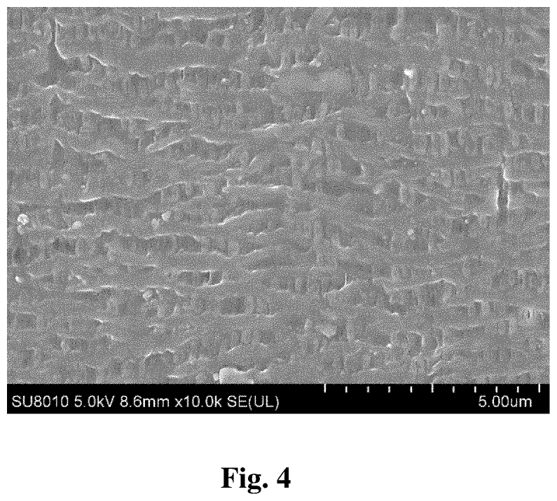

A SEM image of a surface of the PP supporting membrane and a SEM image of a surface of the prepared PDMS/PP hollow fiber composite membrane is shown in FIGS. 3 and 4. It can be clearly seen that the unmodified PP membrane has an obvious microscale pore structure on its membrane surface, and as mentioned above, micropores in the microporous membrane are prone to blockage in practical use, which leads to a decrease of a mass transfer efficiency of the membrane. However, the PDMS/PP composite membrane prepared by PDMS modification has a completely compact surface, which indicates that a continuous and compact PDMS layer has been successfully compounded on the surface of microporous PP supporting membrane.

Ten prepared composite membranes were packed in a PU hose with polyurethane glue, were subjected to a cut end after the glue was completely cured, and were tested for the oxygen permeability and the bubble point pressure of the dry membrane, with air as a gas source and the aeration pressure of 0.01 MPa during the test. The results are shown in Table 2.

TABLE 2

| | | Bubble Point |
|---|---|---|
| | Oxygen Permeability | Pressure of Dry |
| Name | (g O₂/m² day) | Membrane (MPa) |
| PP | — | 0.005 |
| PDMS/PP | 5.16 | 0.05 |

It can be seen from Table 2 that the bubble point pressure of the microporous PP supporting membrane is low due to its microporous structure, which means that a higher aeration pressure cannot be used in the microporous PP membrane during MABR operations, and this will undoubtedly limit an aeration efficiency. However, the bubble point pressure of the PDMS/PP composite membrane prepared by modification is significantly increased, and at the same time also has a high oxygen permeability.

### EXAMPLE 3

A preparation method of a high-performance MABR hollow fiber composite membrane includes the following steps:

1) pretreating a supporting membrane, the supporting membrane is a hydrophobic microporous membrane, and a membrane material thereof is polyvinylidene fluoride (PVDF), the PVDF supporting membrane has an inner diameter of 500 μm a wall thickness of 100 μm, and a membrane surface aperture of 0.1 μm.

The PVDF supporting membrane is soaked in ethanol for 3 minutes, then is soaked within pure water for 3 times each for 5 minutes, and then residual water on a surface of the PVDF supporting membrane are removed with compressed air.

2) preparing a coating solution, in which: vinyl silicone oil is used as the raw silicone rubber, white carbon black is used as the reinforcing material, hydrosilicone oil is used as the crosslinking agent, Karstedt's catalyst is used as the catalyst, and petroleum ether is used as the diluting solvent; and 1 part of vinyl silicone oil and 0.5 part of white carbon black are mixed and stirred for 30 minutes, then 0.05 part of hydrosilicone oil and 0.05 part of Karstedt's catalyst are added and stirred well for 60 minutes, and then a proper amount of petroleum ether is added to make a weight percentage of the raw silicone rubber in the whole solution to be 30 wt %, and finally the Poly(dimethylsiloxane) (PDMS) coating solution is prepared after the vacuum defoaming;

3) coating the pretreated supporting membrane, which includes: placing the pretreated PVDF supporting membrane in step 1) into the coating solution prepared in step 2) for 90 seconds, and then pulling the supporting membrane out of the coating solution at a constant speed by the vertical pulling machine;

4) performing a curing, which includes: placing the resulting membrane obtained in step 3) in an oven at 80° C. for curing until a complete curing is obtained, and obtaining the prepared PDMS/PVDF hollow fiber composite membrane after a complete curing.

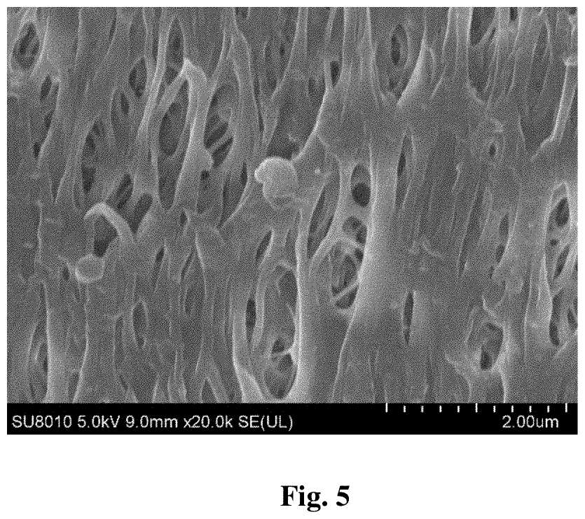

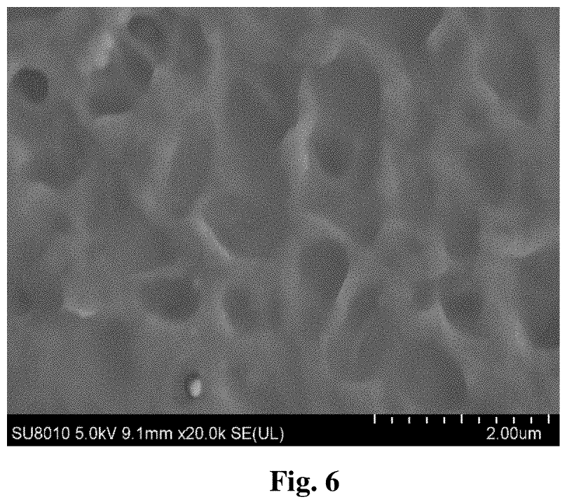

A SEM image of a surface of the PVDF supporting membrane and a SEM image of a surface of the prepared PDMS/PVDF hollow fiber composite membrane is shown in FIGS. 5 and 6. It can be clearly seen that the unmodified PVDF membrane has an obvious microscale pore structure on its membrane surface, and as mentioned above, micropores in the microporous membrane are prone to blockage in practical use, which leads to a decrease of a mass transfer efficiency of the membrane. However, the PDMS/PVDF composite membrane prepared by PDMS modification has a completely compact surface.

Ten prepared composite membranes were packed in a PU hose with polyurethane glue, were subjected to a cut end after the glue was completely cured, and were tested for the oxygen permeability and the bubble point pressure of the dry membrane, with air as a gas source and the aeration pressure of 0.01 MPa during the test. The results are shown in Table 3.

TABLE 3

| | | Bubble Point |
|---|---|---|
| | Oxygen Permeability | Pressure of Dry |
| Name | (g O₂/m² day) | Membrane (MPa) |
| PVDF | — | 0.2 |
| PDMS/PVDF | 2.29 | >0.3 |

It can be seen from Table 3 that the bubble point pressure of the microporous PVDF supporting membrane is low due to its microporous structure, which means that a higher aeration pressure cannot be used in the microporous PVDF membrane during MABR operations, and this will undoubtedly limit an aeration efficiency. However, the bubble point pressure of the PDMS/PVDF composite membrane prepared by modification is significantly increased, and at the same time also has a high oxygen permeability.

### EXAMPLE 4

A preparation method of a high-performance MABR hollow fiber composite membrane includes the following steps:

1) pretreating a supporting membrane, the supporting membrane is a hydrophobic microporous membrane, and a membrane material thereof is polytetrafluoroethylene (PTFE), the PTFE supporting membrane has an inner diameter of 720 μm, a wall thickness of 200 μm, and a membrane surface aperture of 0.8 μm.

The PTFE supporting membrane is soaked in ethanol for 5 minutes, then is soaked within pure water for 2 times each for 5 minutes, and then residual water on the surface of the PTFE supporting membrane are removed with compressed air.

2) preparing a coating solution, in which: vinyl silicone oil is used as the raw silicone rubber, celite is used as the reinforcing material, hydrosilicone oil is used as the crosslinking agent, Karstedt's catalyst is used as the catalyst, and cyclohexane is used as the diluting solvent; and 1 part of vinyl silicone oil and 0.2 part of celite are mixed and stirred for 60 minutes, then 0.2 part of hydrosilicone oil and 0.1 part of Karstedt's catalyst are added and stirred well for 30 minutes, and then a proper amount of cyclohexane is added to make a weight percentage of the raw silicone rubber in the whole solution to be 40 wt %, and finally the Poly(dimethylsiloxane) (PDMS) coating solution is prepared after the vacuum defoaming;

3) coating the pretreated supporting membrane, which includes: placing the pretreated PTFE supporting membrane in step 1) into the coating solution prepared in step 2) for 30 seconds, and then pulling the supporting membrane out of the coating solution at a constant speed by the vertical pulling machine;

4) performing a curing, which includes: placing the resulting membrane obtained in step 3) in an oven at 50° C. for curing until a complete curing is obtained, and obtaining the prepared PDMS/PTFE hollow fiber composite membrane after a complete curing.

Ten prepared composite membranes were packed in a PU hose with polyurethane glue, were subjected to a cut end after the glue was completely cured, and were tested for the oxygen permeability and the bubble point pressure of the dry membrane, with air as a gas source and the aeration pressure of 0.01 MPa during the test. The results are shown in Table 4.

TABLE 4

| | | Bubble Point |
|---|---|---|
| | Oxygen Permeability | Pressure of Dry |
| Name | (g O₂/m² day) | Membrane (MPa) |
| PTFE | — | 0.001 |
| PDMS/PTFE | 6.53 | 0.015 |

It can be seen from Table 4 that the bubble point pressure of the microporous PVDF supporting membrane is low due to its microporous structure, which means that a higher aeration pressure cannot be used in the microporous PVDF membrane during MABR operations, and this will undoubtedly limit an aeration efficiency. However, the bubble point pressure of the PDMS/PTFE composite membrane prepared by modification is significantly increased, and at the same time also has a high oxygen permeability.

### EXAMPLE 5

A preparation method of a high-performance MABR hollow fiber composite membrane includes the following steps:

1) pretreating a supporting membrane, the supporting membrane is a hydrophobic microporous membrane, and a membrane material thereof is polyethylene (PE), the PE supporting membrane has an inner diameter of 300 μm, a wall thickness of 80 μm, and a membrane surface aperture of 0.3 μm.

The PE supporting membrane is soaked in ethanol for 5 minutes, then is soaked within pure water for 2 times each for 10 minutes, and then residual water on the surface of the PE supporting membrane are removed with compressed air.

2) preparing a coating solution, in which: vinyl silicone oil is used as the raw silicone rubber, nano calcium carbonate is used as the reinforcing material, vinyl silicone oil and hydrosilicone oil are used as the crosslinking agent, Karstedt's catalyst is used as the catalyst, and n-heptane is used as the diluting solvent; and 1 part of vinyl silicone oil and 0.1 part of white carbon black are mixed and stirred for 60 minutes, then 0.1 part of hydrosilicone oil, 0.1 part of low molecular vinyl silicone oil and 0.01 part of Karstedt's catalyst are added and stirred well for 30 minutes, and then a proper amount of n-heptane is added to make a weight percentage of the raw silicone rubber in the whole solution to be 40 wt %, and finally the Poly(dimethylsiloxane) (PDMS) coating solution is prepared after a vacuum defoaming;

3) coating the pretreated supporting membrane, which includes: placing the pretreated PE supporting membrane in step 1) into the coating solution prepared in step 2) for 50 seconds, and then pulling the supporting membrane out of the coating solution at a constant speed by a vertical pulling machine;

4) performing a curing, which includes: placing the resulting membrane obtained in step 3) in an oven at 120° C. for curing until a complete curing is obtained, and obtaining the prepared PDMS/PE-2 hollow fiber composite membrane after a complete curing.

Ten prepared composite membranes were packed in a PU hose with polyurethane glue, were subjected to a cut end after the glue was completely cured, and were tested for the oxygen permeability and the bubble point pressure of the dry membrane, with air as a gas source and the aeration pressure of 0.01 MPa during the test. The results are shown in Table 5.

TABLE 5

| | | Bubble Point |
|---|---|---|
| | Oxygen Permeability | Pressure of Dry |
| Name | (g O₂/m² day) | Membrane (MPa) |
| PE | — | 0.0015 |
| PDMS/PE-2 | 9.70 | >0.2 |

It can be seen from Table 5 that the bubble point pressure of the microporous PE supporting membrane is low due to its microporous structure, which means that a higher aeration pressure cannot be used in the microporous PE membrane during MABR operations, and this will undoubtedly limit an aeration efficiency. However, the bubble point pressure of the PDMS/PTFE composite membrane prepared by modification is significantly increased, and at the same time also has an extremely high oxygen permeability.

The foregoing is only preferred embodiments of the present invention, and is not intended to limit an implementation scope of the present invention; and all equivalent changes and modifications made according to the contents of the patent scope of this application fall within the technical scope of the present invention.

What is claimed is:

1. A preparation method of a high-performance MABR hollow fiber composite membrane, wherein the method comprises the following steps:
1) pretreating a supporting membrane, which includes: soaking the supporting membrane in ethanol for 3-5 minutes, soaking the supporting membrane in pure water for 2-5 times each for 5-10 minutes, and then removing residual water on a surface of the supporting membrane with compressed air;
2) preparing a coating solution, which includes: mixing raw silicone rubber and a reinforcing material with a continuous stirring for 30-90 minutes, then adding a crosslinking agent and catalyst and stirring well for 30-60 minutes, and finally adding a diluting solvent to dilute to a required concentration to obtain the coating solution after a vacuum defoaming, the raw silicone rubber, the reinforcing material, the crosslinking agent and catalyst are being in a certain proportion;
3) coating the pretreated supporting membrane, which includes: placing the pretreated supporting membrane in step 1) into the coating solution prepared in step 2) for 30-90 seconds, and then pulling the supporting membrane out of the coating solution at a constant speed by a vertical pulling machine;
4) performing a curing, which includes: placing the resulting membrane obtained in step 3) in an oven at 50-120° C. for curing, and obtaining the hollow fiber composite membrane after a complete curing.

2. The preparation method of the high-performance MABR hollow fiber composite membrane according to claim 1, further comprising step 5), which includes: repeating step 3) and step 4) at least once.

3. The preparation method of the high-performance MABR hollow fiber composite membrane according to claim 1, wherein the supporting membrane described in step 1) is a hydrophobic microporous membrane, a membrane material thereof is polypropylene (PP), polyethylene (PE), polyvinylidene fluoride (PVDF) or polytetrafluoroethylene (PTFE), the microporous membrane has an inner diameter of 300-720 μm, a wall thickness of 80-200 μm, and a membrane surface aperture of 0.1-0.8 μm.

4. The preparation method of the high-performance MABR hollow fiber composite membrane according to claim 1, wherein the raw silicone rubber in step 2) is vinyl silicone oil, the crosslinking agent is low molecular vinyl silicone oil and/or hydrosilicone oil, and the catalyst is Karstedt's catalyst.

5. The preparation method of the high-performance MABR hollow fiber composite membrane according to claim 1, wherein the reinforcing material in step 2) is one or more of white carbon black, celite and nano calcium carbonate.

6. The preparation method of the high-performance MABR hollow fiber composite membrane according to claim 1, wherein the diluting solvent in step 2) is one or more of n-hexane, n-heptane, cyclohexane and petroleum ether.

7. The preparation method of the high-performance MABR hollow fiber composite membrane according to claim 1, wherein when the raw silicone rubber in step 2) is in 1 part by weight, the reinforcing material is 0.05-0.5 part by weight, the crosslinking agent is 0.05-0.2 part by weight, and the catalyst is 0.01-0.1 part by weight, and the dilution solvent is added until a weight percentage of the raw silicone rubber in the whole solution is 10-40 wt %.
